(19) United States
(12) Patent Application Publication
(10) Pub. No.: US 2013/0264314 A1
(43) Pub. Date: Oct. 10, 2013

(54) ELECTRODE FOR ELECTRIC DISCHARGE MACHINING

(71) Applicants: Hirofumi Yamaguchi, Fukuoka (JP); Yuusuke Uchida, Fukuoka (JP)

(72) Inventors: Hirofumi Yamaguchi, Fukuoka (JP); Yuusuke Uchida, Fukuoka (JP)

(73) Assignee: NIPPON TUNGSTEN CO., LTD., Fukuoka (JP)

(21) Appl. No.: 13/880,271

(22) PCT Filed: Oct. 17, 2011
(86) PCT No.: PCT/JP2011/073855

§ 371 Date: Jun. 27, 2013

(30) Foreign Application Priority Data
Oct. 18, 2010 (JP) 2010-233480

(51) Int. Cl. B23H 7/24

(52) U.S. Cl. CPC B23H 7/24
USPC 219/69.15

(57) ABSTRACT

In electro-discharge machining by using an electro-discharge machining electrode of a Cu(Ag)—W(Mo) material, the machining speed, the electrode wear ratio, and the surface roughness of a work piece are improved. For this purpose, to the Cu(Ag)—W(Mo) material, borates of an element selected from a group (M3) consisting of Mg, Ca, Sr, Ba, Sc, Y, and lanthanide and an iron group metal are added by appropriate amounts. As the borate compounds, particularly, it is preferred to use borate compounds expressed by M3₂B₂O₅ and M3B₂O₄.

### TECHNICAL FIELD

The present invention relates to an electro-discharge machining electrode suitable for a machining electrode mainly used for die-sinking electro-discharge machining.

### BACKGROUND ART

As an electro-discharge machining electrode, a material mainly made of a nonmetallic element such as carbon or a material mainly made of a metal including Cu is mainly utilized.

If an electro-discharge machining electrode of carbon or Cu is used, the machining speed can be easily increased by raising the discharge conditions, but the electrode itself is badly worn, and the shape of the electrodes reflected on a work piece. For this reason, such an electrode is not desirable for an application to which precision is required such as electro-discharge machining of a cemented carbide member for dies, for example. In the field to which precision is required, a composite material of Cu or Ag as a material of good conductivity and W (tungsten) which is a metal having high melting point and is superior as an arc-proof element is conventionally used.

In such an application, it is required that the machining speed of work pieces is high, and the electrode itself for machining is less worn in the electro-discharge machining. At the same time, the surface condition of the machining electrode is transferred to the work piece, so that it is also required that there is no pore having a side length exceeding 20 μm, for example, in the surface or the interior of the machining electrode.

Accordingly, materials of electro-discharge machining electrodes obtained by adding various substances to a base material of Cu—W have hitherto been proposed.

Patent Document 1 describes an electro-discharge machining electrode in which borates of alkaline earth metal (a complex oxide of alkaline earth metal and boron) are contained in a Cu—W alloy. When the borates of alkaline earth metal are added to the Cu—W alloy by 0.05% to 5% by mass, the electro-discharge properties are improved, thereby expecting the effect of stabilizing the electric discharge. Patent Document 1 also shows such effects that the machining efficiency can be improved, the electrode has no hygroscopic property, so that it is chemically stable, and the wear-out of the electrode can be reduced.

Patent Document 2 discloses a technology for adding Ni of 0.05% to 0.2% by mass and cerium oxide of 0.1% to 1.0% by mass to an alloy such as Cu—W, Ag—W, or Cu—WC. Patent Document 2 also describes that it is difficult for the sintering to advance with a less amount of Ni, and the addition of cerium oxide of an appropriate amount effectively results in the increase in long life.

Patent Document 3 discloses an electrode material for electro-discharge machining which does not contain 0.05% by mass or more of elements other than Ni, Cu, W, their borides, and their oxides, which is produced by using W particles with particle diameters more than 1 μm and less than 3 μm by 70% or more of all W particles, and in which Vickers hardness (HV) of W skeleton is 22 or more. Since the material does not contain an alkaline earth metal, the sintering is easily advanced. Thus, the sintered bodies can be obtained with the addition of a small amount of Ni, or no addition thereof. Accordingly, in the description, the effects that the wear-out of the electrode can be reduced, the machining speed can be increased, and the machining ability of the electrode itself can be improved are attained.

Patent Document 4 discloses an electro-discharge machining electrode which uses Cu—W alloys including complex oxides of alkaline earth metal (and alkaline metal, rare earth metal, or the like) and W as a material. Patent Document 4 also describes that when 5 mol % or less of at least one of Fe, Co, and Ni is contained in the material, the sintering property can be improved. Patent Document 4 also describes that by uniformly dispersing the complex oxides including W, abnormal electric discharge hardly occurs, the electrode wear ratio can be lowered, and the machining speed can be increased.

### CITATION LIST

### Patent Literature

Patent Document 1: Japanese Laid-Open Patent Publication No. 51-084497
Patent Document 2: Japanese Laid-Open Patent Publication No. 03-146636
Patent Document 3: Japanese Laid-Open Patent Publication No. 2004-130487
Patent Document 4: Japanese Laid-Open Patent Publication No. 2006-315134

### SUMMARY OF INVENTION

### Technical Problem

By any of the above-described conventional methods, certain effects for the increase in the machining speed and the reduction in the wear-out of the electro-discharge machining electrode can be presumably attained. However, the increase in the machining speed and the reduction in the wear-out of the electrode are still more required, and more superior electro-discharge machining electrodes are required.

In addition, as described in Patent Document 1, for example, borate compounds have an effect of increasing the electric discharge characteristics. On the contrary, if the borate compounds are added, negative influence is applied on the sintering property of the material, so that the sintering is not sufficiently advanced, and remaining pores may easily occur in the interior. In the case where electro-discharge machining is performed by using an electrode having the remaining pores, there arises a problem that the machining precision of the work piece is deteriorated.

The present invention has been made in view of the above-mentioned problems, and the objective thereof is to provide an electro-discharge machining electrode in which the electrode wear ratio can be suppressed, and high-speed machining and high-precision machining can be realized.

### Solution to Problem

The electro-discharge machining electrode according to the present invention is an electro-discharge machining electrode used for electro-discharge machining, formed of a material containing the following (A), (B), and (C), in which the sum of the masses of the (A), (B), and (C) accounts for 95% by mass or more and 100% by mass or less of the total mass. Herein (A) is M1 of 5 to 40 parts by mass; (B) is M2 metal of 100 parts by mass in total together with the (A), always containing M2, and containing an alloy of M2 and iron group metal or a simple substance of iron group metal; and (C) is M3 borates of 0.05 to 8 external parts by mass per 100 parts by mass of the total mass of the (A) and the (B). In addition, M1 is at least one of Cu or Ag, or an alloy thereof, M2 is at least one of W or Mo, or an alloy thereof, and M3 is at least one selected from a group consisting of Mg, Ca, Sr, Ba, and rare earth metals.

In one embodiment, the sum of the mass of the simple substance of iron group metal and the mass of the alloy of M2 and iron group metal is 0.05% to 2.5% by mass per the sum of the mass of (A) and the mass of (B).

In one embodiment, the electro-discharge machining electrode is formed of the material further containing the following (D) and (E), wherein the sum of the mass of (A), (B), and (C) and the mass of (D) and (E) accounts for 95% by mass or more and 100% by mass or less of the total mass. Herein (D) is a complex oxide of 0.1 to 5 external parts by mass per the sum of the mass of (A) and the mass of (B), when the sum of the mass of (A) and the mass of (B) is 100 parts by mass, the complex oxide containing the M2, the iron group metal, and at least one of Ca, Sr, Ba, and rare earth metals; and (E) is a boron oxide of 0.1 to 3 parts by mass per the sum of the mass of (A) and the mass of (B), when the sum of the mass of (A) and the mass of (B) is 100 parts by mass.

In one embodiment, the borates of (C) can be expressed by M3ₐB_{b}O_{c}, and the ratio of the borates in which a=2, b=2, and c=5 is 0.1 parts by volume or more and 0.99 parts by volume or less when the total volume of the borates is 1.

In one embodiment, the borates of (C) can be expressed by M3ₐB_{b}O_{c}, and the borates contains: first borates expressed by a=2, b=2, and c=5, and accounting for x parts by volume; second borates expressed by a=1, b=2, and c=4, and accounting for y parts by volume; and third borates accounting for z parts by volume, the third borates being different from both of the first borates and the second borates. The aforementioned x, y, and z satisfy the following relationships (1) to (3). (1) x≧0.1, y≧0.1, (2) x+y≧0.5, and (3) x+y+z=1. In addition, the relationship of z≦0.1 may be satisfied.

In one embodiment, when the total volume of the borates of (C) is 1 parts by volume, 0.5 parts by volume of the borates are dispersed in grain boundaries of M1, M2, a simple substance of the iron group metal, and the alloy of M2 and iron group metal.

In one embodiment, an average particle diameter of the borates of (C) is more than 0 μm and equal to or less than 20 μm, and the maximum particle diameter is more than 0 μm and equal to or less than 150 μm.

### Advantageous Effects of Invention

The electro-discharge machining electrode according to the present invention has superior electric discharge characteristics, thereby improving the machining speed. In addition, the wear ratio of the electro-discharge machining electrode is relatively low, and good surface precision of the work piece can be attained.

Accordingly, the period of time required for the machining of the work piece such as a die can be shortened. In addition, in accordance with the improvement of the machining efficiency, the number of expensive working machines and the cost of the incidental expenses such as maintenance can be reduced, so that the present invention is industrially useful extremely.

### BRIEF DESCRIPTION OF DRAWINGS

FIG. 1 is a schematic diagram showing an organization of an electro-discharge machining electrode in one embodiment of the present invention.

### DESCRIPTION OF EMBODIMENTS

In an electro-discharge machining electrode according to the present invention, in Cu(or Ag)—W(or Mo) alloys, at least one selected from alkaline earth metal elements Ca, Sr, Ba, and rare earth metals in the group 2a of the periodic table with superior electric discharge characteristics is dispersed in the alloy organization in the form of composite borate compounds (M3ₓB_{y}O_{z}, where M3 is at least one selected from the group of Mg, Ca, Sr, Ba, and rare earth metals). By adding an iron group metal (Fe, Co, Ni), the degree of sintering is improved.

More specifically, the electro-discharge machining electrode contains the following materials (A) to (C).

(A): M1 of 5 to 40 parts by mass.

(B): M2 metal of 100 parts by mass in total together with (A), the M2 metal always containing M2, and containing an alloy of M2 and iron group metal and/or a simple substance of the iron group metal.

(C) Borates of M3 of 0.5 to 8 external parts by mass per 100 parts by mass of the total mass of (A) and (B).

Herein M1 is at least one of Cu and Ag or an alloy thereof, M2 is at least one of W and Mo or an alloy thereof, and M3 is at least one metal selected from the group consisting of Mg, Ca, Sr, Ba, and rare earth metals. An iron group metal means at least one of Fe, Co, and Ni. The rare earth metal means at least one selected from the group consisting of Sc and Y as metals in the group 3a and lanthanide elements such as La, Ce, and Sm (lanthanoids including lanthanum).

Although the details will be described later, in addition to the fundamental construction of the electro-discharge machining electrode of M1-M2 which is typically Cu—W, an iron group metal (and/or an alloy of M2 and iron group metal), and the borates of M3 are contained at predetermined ratios, thereby attaining both of the improvement of machining speed and the suppression of electrode wear-out.

The inventors of the present invention studied the case where the borates of Mg, Ca, Sr, or Ba of the alkaline earth metals and the borates of rare earth metal were used as effective additives especially for increasing the machining speed. Similarly to the material containing boron or boride, the composite material of M1-M2 (for example, Cu—W) to which the borate compounds are added has poor degree of sintering, so that pores are likely to remain in the material. Due to the existence of pores, portions of the work piece (portions corresponding to the pores) cannot be discharged unlike the other portions. As a result, the surface precision of the work piece is deteriorated. For this reason, it is necessary to avoid the occurrence of pores in the material as much as possible.

In order to increase the degree of sintering, it is suitable to add iron group metals of Fe, Co, and Ni. The iron group metals have lower melting points as compared with W or Mo. In addition, the iron group metals generate their alloys with W or Mo even at lower temperatures. Therefore, the addition of the iron group metal has the function of promoting the sintering, makes the production easy, and makes the surface precision of the work piece higher.

When the M1-M2 composite material produced by adding borates of Mg, Ca, Sr, Ba, or a rare earth metal and an iron group metal by appropriate amounts is used for the electro-discharge machining electrode, the wear of the electrode can be suppressed to be sufficiently lower as compared with the conventional one.

As for the M1-M2 composite material, in the exemplary case using Cu and W, the alloy is not produced by the reaction thereof, but the material can be obtained in such a condition that Cu is infiltrated in W skeleton due to capillary phenomenon. In this specification, the thus-obtained M1-M2 composite material and the M1-M2 composite material containing additives are sometimes referred to as “M1-M2 alloys” for convenience.

Hereinafter an embodiment of the electro-discharge machining electrode according to the present invention will be described.

The embodiment of the present invention provides an electro-discharge machining electrode formed of a material containing (A): M1, (B): M2 metal, and (C): borates of M3, and the sum of the masses of (A) to (C) accounts for 95% by mass or more and 100% by mass or less of the total mass.

First, the important factor in the M1-M2 alloy used for the electro-discharge machining electrode is the mass ratio between M1 and M2. M1 has higher conductivity but has a lower melting point, and M2 has lower conductivity but has a higher melting point. In the M1-M2 alloy containing a lot of M1, the amount of electrode wear due to the arc generated in the electric discharge is increased. In order to suppress the wear to the practical degree, it is preferred that the amount of M1 is suppressed to have a mass ratio of M1 to M2 of 40:60 or less. This amount means that M2 is 60 parts by mass with respect to M1 of 40 parts by mass. The above-mentioned M2 metal (M2, an iron group metal, and an alloy of M2 and iron group metal) is mainly constituted by M2, so that the same can be said about the M2 metal. That is, it is preferred that M1 is set to be 40 parts by mass or less with respect to the M2 metal of 60 parts by mass.

As for the M1-M2 alloy containing a lot of M2 (or M2 metal), in the case where M2 is excessively contained, the conductivity of M2 is inferior to that of M1, so that the machining speed of the work piece cannot be sufficiently increased. In the case where M1 is less than 5 parts by mass, it is difficult to perform inexpensive production by infiltration. As described above, it is industrially preferred that the amount of M1 is not reduced to the mass ratio between M1 and M2 (or M2 metal) of 5:95 or more. This amount means that M1 is 5 parts by mass with respect to M2 of 95 parts by mass.

By the above-mentioned conditions, the masses of M1 and M2 (or M2 metal) may preferably be set in such manner that M2 (or M2 metal) is 60 to 95 parts by mass with respect to M1 of 5 to 40 parts by mass.

Next, the M2 metal of (B) will be described.

The M2 metal of (B) is 100 parts by mass in total together with M1 of (A). The M2 metal includes M2, an iron group metal, and an alloy of M2 and iron group metal. The mass of the M2 metal means the sum of the mass of M2, the mass of the iron group metal (a simple substance), and the mass of the alloy of M2 and iron group metal (hereinafter the alloy of M2 and iron group metal is sometimes referred to as “M2-iron group alloy”). The M2 metal is typically constituted by M2 of about 95% by mass or more.

As apparent from the composition, the electro-discharge machining electrode according to the embodiment of the present invention contains the iron group metal. The iron group metal easily constitutes an alloy with M2 of W or Mo at low temperatures. Accordingly, even in the case where the borate compounds of (C) as a factor of preventing the sintering which will be described later is added, the sintering is easily progressed, thereby obtaining fine M1-M2 alloys.

The iron group metal fundamentally constitutes an alloy with M2 of W or Mo, so that the iron group metal does not remain as a simple substance after the sintering. However, depending on the conditions such as the amount thereof, the temperature, the rate of temperature elevation, and the atmosphere, part of the iron group metal may sometimes remain as the simple substances. Accordingly, the mass of “the iron group metal” of (B) may have a value of 0 parts by mass in the case where the simple substances thereof do not exist. On the contrary, the situation that the iron group metal does not react with M2 does not occur, so that the mass of M2 and the mass of the alloy of M2 and iron group metal (M2-iron group alloy) cannot have the value of 0 parts by mass. The behavior of the alloy of M2 and iron group metal is similar to that of M2 in the electro-discharge machining, so that the mass of the alloy of M2 and iron group metal is incorporated in the mass of (B) together with M2. In the case where the iron group metal is contained, after the formation of the electrode, it is difficult to separately obtain the mass of the iron group metal and the mass of the alloyed portion. In addition, the remaining mass of the iron group metal is a little as compared with the mass of M2. Accordingly, the mass of the iron group metal is incorporated in the mass of the M2 metal of (B).

(C) is borate compounds for improving the electric discharge characteristics, and borates of M3 having 0.05 to 8 external parts by mass per 100 parts by mass of the total mass of (A) and (B). It is known that all of borides and oxides of Ca, Sr, Ba as alkaline earth metals and rare earth metals have low work functions, so as to improve the electric discharge characteristics. The borate compounds further improves the electric discharge characteristics. In addition, the borate compounds have less function of impeding the infiltration as compared with the borides and the oxides. As the amount of the borate compounds increases, the electric discharge characteristics are more improved, and the machining speed is increased. However, as the amount of the borate compounds increases, the degree of sintering of the M1-M2 alloys is gradually degraded. In the case where the borate compounds are added to an extent exceeding 8 external parts by mass, even if iron group metals are added (existing as an alloy with M2 or a metal of simple substance in the sintered body), the degree of sintering is not sufficiently increased, so that the shape cannot be maintained. Even if the shape can be maintained, it is too fragile to be machined. In order to attain the effect of improving the electric discharge characteristics, it is necessary to add at least 0.05 external parts by mass.

In the embodiment of the present invention, the sum of the above-described (A), (B), and (C) accounts for 95% by mass or more and 100% by mass or less of the total mass of the electro-discharge machining electrode. If the mass amount is less than 5% by mass, components other than (A), (B), and (C) can be allowed in such a range as not affecting the degree of sintering and the electric discharge characteristics. For example, less than 5% by mass of a metal such as Cr, Ti, V Ta, Re, and Au, an alkaline metal such as Na and K, an alkaline earth metal such as Ca, Ba, Sr, carbon, a rare earth metal, and oxides or borides of them, or carbides or nitrides of WC, TiN, Si₃N₄, and SiC may be contained.

In some documents, oxides of boron (B₂O or the like) are dealt as borate compounds. However, in this specification, the oxides of boron are not dealt as the borate compounds.

It is preferred that the sum of the mass of the simple substance of the iron group metal and the mass of the alloy of M2 and iron group metal may be set to account for 0.05 to 2.5 parts by mass with respect to the sum of the masses of (A) and (B).

The iron group metal makes an alloy with W or Mo as described above, so as to increase the degree of sintering. Thus, the number and the size of pores can be reduced to such a degree as not interfering with the use as the electro-discharge electrode. On the other hand, if a large amount of iron group metal is added, the iron group metal dissolves in Cu or Ag, so that the melting point is lowered. As a result, the wear ratio of the electro-discharge machining electrode is undesirably increased. The desirable upper limit so as not to cause remarkable increase of wear-out of the electro-discharge machining electrode is such that the total amount of the mass of the iron group metal and the mass of the alloy of M2 (e.g. W) and iron group metal is 2.5 parts by mass with respect to the sum of the masses of (A) and (B). In addition, if the sum of the mass of the remaining iron group metal and the mass of the alloy of M2 and iron group metal is less than 0.05 parts by mass with respect to the sum of the masses of (A) and (B), the problem of sintering failure due to the existence of borate compounds shown in the above-mentioned (C) is caused, and the pores may easily remain. Accordingly, it is desired that the sum of the mass of the simple substance of iron group metal and the mass of the alloy of M2 and iron group metal may be set to be 0.05 to 2.5 parts by mass with respect to the sum of the masses of (A) and (B).

Alternatively, the electro-discharge machining electrode may be formed of a material in which the sum of the mass of (A), (B), and (C) and the mass of (D) and (E) which will be described below accounts for 95% by mass or more and 100% by mass or less of the total mass.

Herein (D) is a complex oxide of M2, an iron group metal, and at least one metal of Ca, Sr, Ba and rare earth metals, the complex oxide accounting for 0.1 to 5 parts by mass. In addition, (E) is boron oxides of 0.1 to 3 parts by mass (where the sum of the masses of (A) and (B) is 100 parts by mass).

Now (D) is described. In some cases, M2, the iron group metal, and the alkaline earth metal may produce a complex oxide under the existence of oxygen. For example, Sr(Ni. W)_{0.5}O₂ or Ba(Co. W)_{0.5}O₂ corresponds to such a complex oxide. The oxygen source is O released from part of the borate compounds, or a small amount of oxygen contained in M1 and M2. Next, (E) is described. In the atmosphere in which the released B and O can react, when B is oxidized, boron oxides such as B₂O may sometimes be produced.

These complex oxides or boron oxides have the effect of improving the electric discharge characteristics which is somewhat inferior to those of borate compounds. The upper limit of the amount of oxygen is defined eventually based on the amount of borate compounds as described above. It is undesirable that if the complex oxide exceeds 5 parts by mass, it may negatively affect the surface roughness of the work as aggregate. For the same reason, it is undesirable that the boron oxide exceeds 3 parts by mass. If both of them are 0.1 parts by mass or less, any remarkable difference in effects is not found as compared with an electro-discharge machining electrode which contains none of them.

In addition, the borates of M3 of (C) can be represented by M3ₐB_{b}O_{c}. It is preferable that the ratio of borate compounds in which a=2, b=2, and c=5 be set to be 0.5 parts by volume or more and 0.99 parts by volume or less in the case where the total volume of the borate compounds is 1.

Alternatively, the borates of M3 of (C) may contain x parts by volume of first borate compounds in which a=2, b=2, and c=5, y parts by volume of second borate compounds in which a=1, b=2, and c=4, and z parts by volume of third borate compounds which are different from both of the first borate compounds and the second borate compounds. Preferably, x, y, and z satisfy the following relationships (1), (2), and (3).

x≧0.1,y≧0.1, (1)

x+y∝0.5, and (2)

x+y+z=1. (3)

In addition, they may further satisfy the relationship of z≧0.1.

The inventors of the present invention found that the specific form of borate compounds with higher electric discharge effect and for improving the machining speed is a compound in which a=2, b=2, and c=5 when the borate compound is represented by M3ₐB_{b}O_{c}.

The borate compounds of Ca, Sr, Ba, and rare earth metals can take a plurality of forms. In the case where they are represented by the aforementioned expression, the following borate compounds are the representative ones.

a=1, b=2, c=4

a=1, b=1, c=3

a=1, b=4, c=7

a=1, b=6, c=10

a=1, b=8, c=13

a=2, b=3, c=11

a=2, b=2, c=5

a=3, b=2, c=6

a=3, b=4, c=9

a=3, b=10, c=18

a=9, b=2, c=6

Additionally, any other forms can be taken.

The inventors of the present invention found that among them, the best suitable one which could exist in the M1-M2 alloy stably in the sintering process and in the use and which had high electric discharge effect had the relationship of a=2, b=2, and c=5, and found that the second suitable one had the relationship of a=1, b=2, and c=4. It is preferred that the borate compounds shown by a=2, b=2, and c=5 account for 10% by volume or more of the whole of the borate compounds. More preferably, the borate compounds account for 50% by volume or more. However, it is difficult to obtain pure particles, and in some cases, the borate compounds may be changed into any other borate compounds mainly in the sintering, so that the actual upper limit is 99% by volume.

As for the borate compounds having relationships other than a=2, b=2, and c=5, and a=1, b=2, and c=4, the electric discharge characteristics are lower than those of the two. Accordingly, the amount is desirably 0.1 parts by volume or less with respect to the total volume of the borate compounds. At the same time, as for the former two, the sum of the volumes is preferably 0.5% by volume or more. More preferably, it is 0.9 parts by volume or more.

In the borate compounds of M3 of (C), when the total volume of the borate compounds of one, or two or more selected from the group of Mg, Ca, Sr, Ba, and rare earth metals is assumed to be 1 parts by volume, the volume of 0.5 parts by volume or more may be dispersed in the grain boundary of M1, M2, the iron group metal, and the alloy of M2 and iron group metal.

As for the borate compounds, the electric discharge characteristics are different between the case where they exist in the particles of M1 (Cu, Ag), M2 (W, Mo), or the like, and the case where they exist in the grain boundary. The borate compounds have higher electric discharge characteristics in the case where they exist in the grain boundary. For this reason, it is advantageous that they exist in the grain boundary as much as possible in view of the characteristics of the electro-discharge machining electrode. Accordingly, at least the half of the borate compounds preferably exists in the grain boundary.

In the borate compounds of M3 of (C), an average particle diameter of the borate compounds of one, or two or more selected from the group of Mg, Ca, Sr, and Ba is 20 μm or less (it is noted that 0 μm is excluded). The maximum particle diameter may be 150 μm or less.

In the electro-discharge machining, when the condition where a small number of borate compounds having larger particle diameter are exposed to the surface is compared with the condition where a large number of borate compounds having smaller particle diameter are exposed to the surface, the latter case is suitable for increasing the machining speed. In addition, the latter case can reduce the surface roughness of the work piece because the electric discharge can be uniformly performed over the entire surface. If the same amounts of borate compounds are used, the number of borate compounds exposed to the surface is further increased in the case of the smaller average particle diameter. Accordingly, the average particle diameter is desirably smaller. In this case, the upper limit of the average particle diameter is desirably 20 μm or less, and more desirably 10 μm or less. In addition, the maximum value is preferably 150 μm or less. If the particle diameter exceeds the aforementioned values, it may disadvantageously affect the surface roughness of the work piece. The average particle diameter and the maximum particle diameter can be estimated by the area and the number of particles included in a certain area in the microphotograph, for example.

The electro-discharge machining electrode in the above-described preferred embodiment of the present invention can be obtained by the process steps which will be described below, for example.

(1) Production of M2 Skeleton

The M2 skeleton is produced from a condition where the powder of iron group metal and the powder of borate compounds are mixed into the powder of W or Mo as M2. Specifically, components of the electro-discharge machining electrode other than Cu and Ag (M1) are added in the step of producing the M2 skeleton.

It is preferred that the W powder and the Mo powder are appropriately selected in such a manner that the particle size is about 0.1 to 100 μm, and the purity is 99% or more.

As for the iron group metals, particles having diameters as small as possible are selected so as not to cause aggregation. Particles which can be used are those having average particle diameters of 200 μm or less, and desirably of 100 μm or less.

As for the powder of borate compounds, it is necessary to prepare the powder of desired borate compounds before the mixing step.

The powder of borate compounds in this embodiment can be obtained by mixing oxides or carbonate compounds of Mg, Ca, Sr, Ba, and rare earth metals with a substance containing boron such as boron carbide or boron carbonate, and then performing thermal treatment in an oxidizing atmosphere. Depending on the oxygen concentration and the temperature for the thermal treatment, borate compounds of various forms (different values of a, b, and c) can be obtained. Alternatively, by pulverizing the obtained borate compounds by an attritor or the like in a non-deoxidization atmosphere such as the oxidizing atmosphere, powder of borate compounds with smaller particle diameter can be obtained.

The obtained powder of borate compounds, the M2 powder, and the iron group metal powder are mixed. For the mixing, an attritor, a blender, a Henschel mixer, a ball mill, a milling machine, or the like can be used. At this time, the powder of W or Mo is easily oxidized, so that it is desired to use a methanol atmosphere or the like. It is necessary to sufficiently perform the mixing process so as to uniformly mix the iron group metal powder and the borate compounds powder.

In this process, components other than (A), (B), (C), (D), and (E) can be contained intentionally. For example, in the case where oxides or borides are contained, the same process as that for the borate compounds can be performed. In another case where a metal having a low melting point such as Al or Cr is contained, the same process as that for Cu which will be described later can be performed. In this specification, the description in the case where the components other than (A), (B), (C), (D), and (E) is added intentionally is omitted hereafter.

The mixed powder obtained by the mixture is molded by pressing with a die or cold isostatic pressing at about 5 to 150 MPa after adding a molding binder as necessary, and then heated at temperatures of about 900 to 1600° C. in the deoxidization (reducing) atmosphere such as the H₂ atmosphere for a required period of time from five minutes to six hours which is largely different depending on the size of the compact. It is sufficient to reach the condition, after the heating, where M2 particles coming into contact with each other start the necking. At this time, the pores between M2 particles are continuous, and sufficient strength for handling is held.

The added iron group metal (Ni, Co, or the like) forms an alloy with W or Mo, so that it is useful for helping the necking of M2 particles and advancing the densification of the skeleton, and also useful for increasing the strength of the skeleton. On the other hand, the borate compounds (SrB₂O₄ or the like) has low wettability with M2, which prevents the softening and necking of the M2 particles. Accordingly, due to the addition of the borate compounds, the M2 skeleton is susceptible to collapse and involves a problem in handling. However, if the iron group metal is added as described above, even in the case where the borate compounds are added, it is possible to obtain the M2 skeleton having sufficient strength for handling and for the succeeding production steps.

(2) Infiltration of M1

Into the M2 skeleton obtained in the process (1), Cu and/or Ag as M1 is infiltrated.

If a diameter of continuous pore existing in the M2 skeleton is small to some extent, Cu or Ag can be infiltrated into the M2 skeleton by capillary phenomenon by setting the temperature equal to or higher than the melting point of Cu or Ag.

The infiltration is performed by using a heat-resistant container such as ceramics, carbon, or the like, in such a manner that the M2 skeleton is laid in M1 of which the amount is sufficient for the infiltration or that M1 is placed so as to come into contact with the M2 skeleton in the condition where M1 is molten. In such a condition, in the reducing atmosphere such as the H₂ atmosphere, heating is performed to the temperatures equal to or higher than 1084° C. which is the melting point of Cu or 962° C. which is the melting point of Ag. Due to the capillary phenomenon, when M1 is sufficiently infiltrated into the M2 skeleton, the material is completed.

The obtained material is worked into a desired shape of an electro-discharge machining electrode, thereby obtaining an electro-discharge machining electrode in the embodiment of the present invention.

Hereinafter examples of the present invention will be described.

### Example 1

As a material to form W skeleton, W of 79 parts by mass having an average particle diameter of 4 μm, Ni of 1 parts by mass having an average particle diameter of 1 μm, and Sr borates of 0.4 external parts by mass having an average particle diameter of 7 μm was prepared.

The Sr borates to be used were obtained by mixing SrCO₃ and B₂O₃ having an average particle diameter of 5 μm at the mass ratio of 2:1, and then baking for thirty minutes at 1050° C. under the atmospheric environment.

The powder thereof was mixed by Henschel mixer for thirty minutes, thereby obtaining the mixed powder.

Then, the mixed powder was pressed by using a die at a pressure of 50 MPa, thereby obtaining a rod-like compact.

A recessed portion in which the compact was sufficiently accommodated was provided in a heat-resistant container, and the compact was placed in the recessed portion. Then, the sintering was performed for sixty minutes at 1150° C. in the H₂ atmosphere, thereby obtaining the skeleton.

On the skeleton, Cu having a plate-like shape of an amount sufficient for the infiltration was placed, and in this condition, the infiltration was performed for twenty minutes at 1100° C. in the H₂ atmosphere, thereby obtaining a material for an electro-discharge machining electrode.

Then, extra Cu which was not infiltrated was removed from the obtained material, and cutting work was performed by a fraise machine, thereby obtaining a rod-like shape of electro-discharge machining electrode. Thus, an electro-discharge machining electrode used for testing was produced. The mass of Cu which was infiltrated was 20 parts by mass with respect to the total mass (=80 parts by mass) of W and Ni.

The specimen is referred to as Specimen 1.

Composition analysis was performed for the cross-section of Specimen 1 by XRD (X-ray diffraction). Part of W made an alloy with Ni, so that Ni was not observed as a simple substance. In addition, when it was observed by EPMA (Electron Prove Micro Analyzer), it was confirmed that a large portion of the borate compounds existed in the grain boundary between Cu and W (or an alloy of W and Ni). When the borate compounds were measured by XRD, 90% of Sr₂B₂O₅ and 10% of SrB₂O₄ at the peak intensity ratio were observed.

The electro-discharge machining test was performed by using the electro-discharge machining electrode.

In the electro-discharge machining test, as a work (a work piece), WC-based cemented carbide containing 18% by mass of Co and having a relative density of 99.8% or more was used. As a testing machine, “Die-Sinking Electric Discharge Machine DIAX-M35K” by Mitsubishi Electric Corporation was used. As the machining conditions, the machining condition pack for working machine “#9405 (the cemented carbide machining conditions)” was used. The machining was performed under the detailed conditions in Table 1, and the machining speed, the wear amount of the electro-discharge machining electrode, and the surface roughness of the cemented carbide after the machining were evaluated.

As for the machining speed, how many milligrams of cemented carbide as a work could be removed for one minute was measured. The unit is mg/sec. The measurement was performed by the amount of mass reduction of the work and the machining time.

As for the wear amount of the electro-discharge machining electrode, the machined volume of the cemented carbide as the work was regarded as 100%, and as compared with this, the wear ratio (% by volume) of the electro-discharge machining electrode was obtained. In the measurement, the respective masses of the work of cemented carbide and the electro-discharge machining electrode were measured before and after the machining, and the resultant amount was obtained by calculation based on the difference between them.

The surface roughness of the work after the machining reflects the unevenness of the electro-discharge machining electrode. Especially in this experiment, in order to evaluate the surface roughness caused by the components other then W and Cu, for example, the unevenness influenced by the pores and the particles of borate compounds, Ry (the maximum height, JIS1994) was evaluated.

TABLE 1

| Condition | | | |
|---|---|---|---|
| No. | Item | Symbol | Setting |
| 1 | Circuit Setting | EP-SEL | SP |
| 2 | OP Sensitivity | OPAJ | 8 |
| 3 | Polarity Switching | POL | (—) |
| 4 | Auxiliary power supply notch | AUX | 5 |
| 5 | Machining Setting | Ip | 2 |
| 6 | Electric Discharge Stability | JUMP | 1 |
| 7 | Machining Setting fine | [symbol] Ip | 3 |
| | adjustment | | |
| 8 | Servo switching | GAP | 10 |
| 9 | Pulse Width | ON | 1 |
| 10 | Pulse Width fine adjustment | [symbol] ON | 0 |
| 11 | Downtime | OFF | 7 |
| 12 | Downtime fine adjustment | [symbol] OFF | 0 |
| 13 | Electro-discharge stably | JUMPU | 1 |
| | elevating distance | | |
| 14 | Machining adjustment | GAIN | 80 |
| 15 | Electro-discharge stable | JUMPD | 4 |
| | machining time | | |
| 16 | Capacitor switching | PCON | 0 |

As the result of the experiment, as for Specimen 1, the evaluation results of the machining speed of 85.0 (mg/sec), the wear ratio of 9.0(%), and the surface roughness of 15.1 Ry (μm) were obtained.

Next, by using comparative materials in Table 2 and Table 3 shown below, the same experiments were performed. The compositions of the comparative specimens are shown in Tables 2 and 3, and the evaluated results after the experiments are shown in Tables 4 and 5.

*Comparative specimen 1 is a composite material of Cu or Ag and W only, *Comparative specimen 2 is a composite material of Cu—W-borate compounds, *Comparative specimen 3 is a composite material of Cu(Ag)-W-iron group metal, *Comparative specimen 4 is a composite material of Cu—W-iron group metal-oxide, *Comparative specimen 5 is a composite material of Cu—W-iron group metal-boride, and *Comparative specimen 6 is a composite material of Cu(Ag)—W-iron group metal-oxide-boride. For the respective comparative specimens, a branch number indicates the different one in composition (the same hereinafter).

The iron group metals in *Comparative specimens 3 to 6 were added in the form of iron group metals when they were added, but after the infiltration, part of or all of them formed alloys with W. As for the comparative specimens in Table 2, the iron group metal and the alloy of W and the iron group metal after the infiltration are not distinguished, and they are represented by the amount of mixture. When the sum of M1 (Cu or Ag), M2 (W, Mo), and the iron group metal as the mixed raw materials was regarded as 100 parts by mass, the borate compounds, the oxides, and borides were regarded as “additives”, and the parts by mass of the additives per the 100 parts by mass were written (sometimes referred to as an external parts by mass).

TABLE 2

| | | | | Additive (C) |
|---|---|---|---|---|
| Comparative | Cu, Ag (A) | W (B) | Fe, Co, Ni | (External |
| specimen | (parts | (parts | (B) (parts | parts |
| No. | by mass) | by mass) | by mass) | by mass) |
| *1-1 | 10Cu | 90 | — | — |
| *1-2 | 20Cu | 80 | — | — |
| *1-3 | 30Cu | 70 | — | — |
| *1-4 | 20Ag | 80 | — | — |
| *2-1 | 15Cu | 85 | — | 1.0SrB₂O₄ |
| *2-2 | 20Cu | 80 | — | 1.5SrB₂O₄ |
| *2-3 | 20Cu | 80 | — | 1.5BaB₂O₄ |
| *2-4 | 25Cu | 75 | — | 1.0Ca₂B₂O₅ |
| *3-1 | 20Cu | 79.5 | 0.5Ni | — |
| *3-2 | 20Cu | 79.6 | 0.4Co | — |
| *3-3 | 25Cu | 74.6 | 0.4Ni | — |
| *3-4 | 25Ag | 74.5 | 0.5Co | — |

These specimens bearing the * symbol on their Nos. in the table are Comparative specimens lying outside the scope of the present invention.

TABLE 3

| | | | | Additive |
|---|---|---|---|---|
| Comparative | Cu or Ag | W | Fe, Co, | (External |
| specimen | (parts | (parts | Ni (parts | parts |
| No. | by mass) | by mass) | by mass) | by mass) |
| *4-1 | 15Cu | 84.8 | 0.2Ni | 1.5B₂O |
| *4-2 | 20Cu | 79.8 | 0.2Ni | 1.0BaO + 0.5CaO |
| *4-3 | 30Cu | 69.6 | 0.2Ni + | 0.5CeO₂ + 0.5SrO |
| | | | 0.2Co | |
| *4-4 | 20Ag | 79.2 | 0.8Ni | 0.5ZrO₂ |
| *5-1 | 15Cu | 84.2 | 0.8Ni | 1.0SrB₂ |
| *5-2 | 20Cu | 79.2 | 0.8Co | 1.0BaB₂ |
| *5-3 | 20Cu | 79.2 | 0.8Fe | 1.5BaB₂ |
| *6-1 | 15Cu | 84.0 | 1.0Ni | 1.0SrO |
| *6-2 | 20Cu | 79.6 | 0.2Ni + | 1.0CaO + 0.5BaB₂ |
| | | | 0.2Co | |
| *6-3 | 20Ag | 79.0 | 0.5Ni + | 1.5BaSrO₄ + |
| | | | 0.5Fe | 0.5CaB₂ |
| *6-4 | 25Cu | 74.0 | 1.0Ni | 1.0CeO₂ + |
| | | | | 1.0SrB₂ |
| *6-5 | 25Ag | 74.0 | 1.0Co | 1.0BaO + 0.5BaB₂ |

These specimens bearing the * symbol on their Nos. in the table are Comparative specimens lying outside the scope of the present invention.

TABLE 4

| Comparative | Machining | Wear | Surface |
|---|---|---|---|
| specimen | speed | ratio | roughness |
| No. | (mg/sec) | (%) | Ry(μm) |
| (Example | 85.0 | 9.0 | 15.1 |
| Specimen 1) | | | |
| *1-1 | 63.2 | 17.7 | 20.1 |
| *1-2 | 60.8 | 18.5 | 20.4 |
| *1-3 | 52.2 | 19.0 | 19.8 |
| *1-4 | 68.2 | 16.1 | 17.4 |
| *2-1 | 69.0 | 17.5 | 25.7 |
| *2-2 | 69.4 | 17.7 | 25.5 |
| *2-3 | 70.2 | 17.6 | 25.6 |
| *2-4 | 65.8 | 18.5 | 25.0 |
| *3-1 | 66.3 | 16.5 | 17.1 |
| *3-2 | 69.4 | 16.6 | 18.0 |
| *3-3 | 66.7 | 17.0 | 16.7 |
| *3-4 | 72.0 | 15.5 | 16.9 |

These specimens bearing the * symbol on their Nos. in the table are Comparative specimens lying outside the scope of the present invention.

TABLE 5

| Comparative | Machining | Wear | Surface |
|---|---|---|---|
| specimen | speed | ratio | roughness |
| No. | (mg/sec) | (%) | Ry(μm) |
| *4-1 | 72.1 | 16.2 | 16.2 |
| *4-2 | 72.5 | 17.3 | 15.9 |
| *4-3 | 68.4 | 17.0 | 17.0 |
| *4-4 | 73.0 | 15.5 | 16.3 |
| *5-1 | 72.1 | 16.0 | 17.1 |
| *5-2 | 68.2 | 16.8 | 16.6 |
| *5-3 | 70.8 | 16.2 | 16.0 |
| *6-1 | 73.2 | 18.5 | 17.5 |
| *6-2 | 72.1 | 17.0 | 17.6 |
| *6-3 | 72.0 | 15.5 | 16.9 |
| *6-4 | 69.0 | 16.4 | 17.4 |
| *6-5 | 73.1 | 16.0 | 16.6 |

These specimens bearing the * symbol on their Nos. in the table are Comparative specimens lying outside the scope of the present invention.

By the comparison of the results of experiments of Specimen 1 and *Comparative specimens 1 to 6, the followings were found.

First, as for the composite material of only Cu—W in *Comparative specimen 1, both of the machining speed and the wear ratio were apparently inferior to those of Specimen 1. This is because any additive which improves the electric discharge characteristics was not added. The surface roughness was only slightly inferior as compared with Specimen 1. It is considered that this is because since a component other than Cu and W, especially a component having insulating properties is not contained, the surface of the work can be uniformly machined, thereby consequently obtaining good flatness.

As for *Comparative specimen 2, the machining speed, the wear ratio, and the surface roughness were inferior as compared with Specimen 1. Especially, the surface roughness is remarkably inferior. It is considered that this is because the additive of borate compounds having good electric discharge characteristics is added, but it is difficult for the infiltration to be advanced by the influence of the additive, so that pores of certain sizes remain in the interior.

As for *Comparative specimen 3, the surface roughness was slightly inferior as compared with Specimen 1, but the machining speed and wear ratio were largely inferior to those of Specimen 1. It is considered that because the additive having high electric discharge characteristics which was added to Specimen 1 was not contained, the machining speed and the wear ratio were largely inferior. As for the surface roughness, it was only slightly inferior to that of Specimen 1, but slightly superior to that of *Comparative specimen 1.

As for *Comparative specimens 4 and 5, all of the machining speed, the wear ratio, and the surface roughness were inferior as compared with Specimen 1. Among them, the machining speed was largely inferior. It was confirmed that as compared with the borate compounds used in this application, the electric discharge characteristics in the electro-discharge machining electrodes to which borides or oxides were added, respectively, were not improved so much as the case where the borate compounds were added. The surface roughness was slightly inferior to that of Specimen 1.

*Comparative specimen 6 indicates the same tendencies as those of *Comparative specimen 4 and *Comparative specimen 5. From the tendencies, it was confirmed that the electric discharge characteristics in the case where the oxide particles and the boride particles exist in the form of the borate compounds were apparently superior to those in the case where they existed separately. As for the surface roughness, since the sintering was easily advanced due to the iron group metal, the surface roughness is slightly inferior to that of Specimen 1.

### Example 2

Next, the same experiments as those of Specimen 1 were performed by using a specimen in which the mass ratio between M1 and M2 metal was varied, or a specimen in which different kinds were selected in the iron group metal, the alloy of M2 and iron group metal, and the borate compounds of one or more of Mg, Ca, Sr, Ba, and the rare earth metals.

The compositions of the respective specimens are shown in Table 6 and Table 7, and the evaluated results are shown in Table 8 and Table 9.

As for W, the iron group metal, and the alloy of iron group metal, X-ray diffraction was performed for the material after the sintering, and the amounts were identified by means of the peak ratio.

TABLE 6

| | | | | Alloy of | |
|---|---|---|---|---|---|
| | | | | M2 and | Borate |
| | M1 (A) | M2 (B) | Iron | Iron group | compounds (C) |
| | (Cu, Ag) | (W, Mo) | group (B) | metal (B) | (external |
| Specimen | (pars | (pars | (parts | (parts | parts by |
| No. | by mass) | by mass) | by mass) | by mass) | mass) |
| *101 | 3Cu | 96.5W | 0 | 0.5 W—Ni | 0.4SrB₂O₄ |
| 102 | 5Cu | 94.5W | 0 | 0.5 W—Ni | 0.4SrB₂O₄ |
| 103 | 10Cu | 89.5 W | 0 | 0.5 W—Ni | 0.4SrB₂O₄ |
| 104 | 20Cu | 79.5W | 0 | 0.5 W—Ni | 0.4SrB₂O₄ |
| 105 | 30Cu | 69.5 W | 0 | 0.5 W—Ni | 0.4SrB₂O₄ |
| 106 | 40Cu | 59.5W | 0 | 0.5 W—Ni | 0.4SrB₂O₄ |
| *107 | 45Cu | 54.5W | 0 | 0.5 W—Ni | 0.4SrB₂O₄ |
| 108 | 5Ag | 94.5Mo | 0 | 0.5 Mo—Co | 0.6Ba₂B₂O₅ |
| 109 | 40Ag | 59.5Mo | 0 | 0.5 Mo—Co | 0.6Ba₂B₂O₅ |
| 110 | 20Cu | 79.5W | 0 | 0.5 W—Ni | 0.4MgB₂O₄ |
| 104-1 | 20Cu | 79.95W | 0 | 0.05 W—Fe | 0.4Ca₂B₂O₅ |
| 104-2 | 20Cu | 79.8W | 0 | 0.2 W—Fe | 0.4Ca₂B₂O₅ |
| 104-3 | 20Cu | 79.0W | 0 | 1.0 W—Fe | 0.4Ca₂B₂O₅ |
| 104-4 | 20Cu | 77.5W | 0 | 2.5 W—Fe | 0.4Ca₂B₂O₅ |
| **160 | 20Cu | 79.5W | 0 | 0.5 Ni | 0.4SrB₂O₄ + *C |

These specimens bearing the * symbol on their Nos. in the table are Comparative specimens lying outside the scope of the present invention. The specimen bearing the ** symbol in the table has the composition containing Cr of 5% by external mass as *C.

TABLE 7

| | | | | Alloy of | |
|---|---|---|---|---|---|
| | | | | M2 and | Borate |
| | M1 (A) | M2 (B) | Iron | Iron group | compounds (C) |
| | (Cu, Ag) | (W, Mo) | group(B) | metal(B) | (external |
| Specimen | (parts | (parts | (parts | (parts | parts by |
| No. | by mass) | by mass) | by mass) | by mass) | mass) |
| *104-5 | 20Cu | 79.95W | 0 | 0.05 W—Ni | 0.01 LaBO₃ |
| 104-6 | 20Cu | 79.95W | 0 | 0.05 W—Ni | 0.05 LaBO₃ |
| 104-7 | 20Cu | 79.95W | 0 | 0.05 W—Ni | 0.5 LaBO₃ |
| 104-8 | 20Cu | 79.95W | 0 | 0.05 W—Ni | 2 LaBO₃ |
| 104-9 | 20Cu | 79.95W | 0 | 0.05 W—Ni | 8 LaBO₃ |
| *104-20 | 20Cu | 79.95W | 0 | 0.05 W—Ni | 20 LaBO₃ |
| 104-21 | 20Cu | 79.5 Mo | 0.1 | 0.4 Mo-Mi | 0.6Ba₂B₂O₅ |
| 104-22 | 40Ag | 55.0 Mo | 1.0 | 4.0 Mo—Ni | 0.6Ba₂B₂O₅ |

These specimens bearing the * symbol on their Nos. in the table are Comparative specimens lying outside the scope of the present invention.

TABLE 8

| | Machining | Wear | Surface |
|---|---|---|---|
| Specimen | speed | ratio | roughness |
| No. | (mg/sec) | (%) | Ry(μm) |
| *101 | 65.2 | 14.5 | 22.1 |
| 102 | 85.3 | 8.5 | 16.7 |
| 103 | 90.6 | 7.5 | 16.1 |
| 104 | 85.9 | 7.9 | 16.2 |
| 105 | 83.4 | 11.2 | 15.8 |
| 106 | 80.0 | 14.5 | 15.5 |
| *107 | 76.6 | 17.5 | 20.0 |
| 108 | 92.3 | 7.5 | 17.2 |
| 109 | 85.2 | 12.1 | 15.9 |
| 110 | 85.2 | 8.7 | 17.0 |
| 104-1 | 83.6 | 11.1 | 17.2 |
| 104-2 | 87.7 | 9.0 | 18.0 |
| 104-3 | 85.3 | 9.5 | 17.4 |
| 104-4 | 79.0 | 11.5 | 17.6 |
| **160 | 75.1 | 14.9 | 19.9 |

These specimens bearing the * symbol on their Nos. in the table are Comparative specimens lying outside the scope of the present invention.

TABLE 9

| | Machining | Wear | Surface |
|---|---|---|---|
| Specimen | speed | ratio | roughness |
| No. | (mg/sec) | (%) | Ry(μm) |
| *104-5 | 68.4 | 17.0 | 17.0 |
| 104-6 | 80.0 | 10.3 | 16.9 |
| 104-7 | 84.0 | 9.0 | 18.0 |
| 104-8 | 90.3 | 8.9 | 19.1 |
| 104-9 | 80.8 | 11.2 | 20.0 |
| *104-20 | Fragile sintered body, | | |
| | Not successfully formed | | |
| 104-21 | 86.4 | 12.3 | 15.8 |
| 104-22 | 75.2 | 14.7 | 19.2 |

These specimens bearing the * symbol on their Nos. in the table are Comparative specimens lying outside the scope of the present invention.

From the results shown in Table 8 and Table 9, the following can be considered.

From the results of Specimen 1 and Specimens 101 to 110, it was found that in the case of (A)+(B)=100 parts by mass, the specimen (Example) having the mass of (A) of 5 to 40 parts by mass and the mass of (B) of 60 to 95 parts by mass had superior properties, i.e. the machining speed of 75 (mg/sec) or more, the wear ratio of 15(%) or less, and the surface roughness of 20 Ry(μm).

On the other hand, as in the result of *Comparative specimen 101, if the mass of (A) was less than 5 parts by mass, the wear ratio could be ensured, but the machining speed was largely inferior. It is considered that this is because the amount of Cu or Ag is relatively insufficient, so that the conductivity as a whole is degraded. If the mass of (A) exceeded 40 parts by mass as in *Comparative specimen 107, the machining speed could be ensured to some extent, but the wear ratio was largely inferior. It is considered that this is because the absolute amount of Cu or Ag having a low melting point is too much, so that the electro-discharge machining electrode is drastically worn out. From the result, it was found that it was suitable that the mass of (A) be 5 to 40 parts by mass and the mass of (B) be 60 to 95 parts by mass with respect to the condition of (A)+(B)=100 parts by mass.

From the results of Specimens 104-1 to 104-4, it was found that if the sum of the mass of the simple substance of the iron group metal and the mass of the alloy of M2 and iron group metal (M2-iron group alloy) was in the range of 0.05 to 2.5 parts by mass with respect to (A)+(B)=100 parts by mass, relatively good characteristics could be obtained. In the specimen in which the above-mentioned sum is less than 0.05 parts by mass, the effect of improving the electric discharge characteristics is poor. In the specimen in which the sum exceeds 2.5 parts by mass, the effect of improving the electric discharge characteristics is exhibited, but the characteristics are inferior as compared with the specimen of 0.05 to 2.5 parts by mass. From these consideration, it was suitable that the sum of the mass of the iron group metal and the mass of the alloy of M2 and iron group metal be 0.05 to 2.5 parts by mass when the sum of (A) and (B) is 100 parts by mass.

From the results of Specimens 104-5 to 104-9, the specimens having the borate compounds containing one, or two or more kinds of Mg, Ca, Sr, Ba, and rare earth elements in the range of 0.05 to 8 parts by mass could obtain superior characteristics. In the specimen having the borate compounds less than 0.05 parts by mass as in *Comparative specimen 104-5, the wear ratio and the machining speed which were substantially equal to those in *Comparative specimen 4 and *Comparative specimen 5 could be obtained only. It is considered that this is because the amount of borate compounds with superior electric discharge characteristics was entirely insufficient, so that the wear ratio was high and the machining speed was lowered. In addition, in the case where the borate compounds exceeding 8 parts by mass was added, the degree of sintering was remarkably deteriorated, and a sintered body which could resist the handing could not be obtained in *Comparative specimen 104-20. From these results, the appropriate amount of borate compounds was 0.05 to 8 external parts by mass with respect to 100 parts by mass of (A) and (B).

Almost all of the specimens of iron group metals were not observed as simple substances, but they formed alloys by reacting with M2 metal (W, Mo). By adjusting the amount of iron group metal to be added, the iron group metals were observed in the sintered body in Specimen 104-9 and Specimen 104-21. Both of the specimens had the same performances as compared with other examples in which the iron group metal did not exist in the form of simple substance.

In the specimen in which the sum of the mass of the iron group metal of the simple substance and the mass of the alloy of M2 and iron group metal was 0.05 to 2.5 parts by mass with respect to the mass of (A)+(B) (100 parts by mass), sufficient performances thereof exhibited. The specimens in this range exhibited superior characteristics of all of the machining speed, the wear ratio, and the surface roughness. In Specimen 104-22 in which the sum of the mass of the iron group metal of simple substance and the mass of the alloy of M2 and iron group metal was 5 parts by mass which exceeds 2.5 parts by mass with respect to the sum of the masses of (A) and (B) of 100 parts by mass, the wear ratio was slightly inferior to the specimen in the above-mentioned range. It is considered that this is because the mass of the iron group metal with a lower melting point and the mass of the alloy of M2 and iron group metal with a lower melting point as compared with M2 are relatively large, so that the wear due to the electric discharge is easily advanced.

Specimen 160 is an example containing Cr of 5 external % by mass as the composition which is not included in (A), (B), and (C). In the case where the whole of the electrode material is 100% by mass, Cr is 4.7% by mass and the remaining portion of 95.3% by mass which is the sum of (A), (B), and (C). This specimen exhibited superior performances with respect to the comparative specimens. As is seen from the specimen, up to 5% by mass of the electro-discharge machining electrode, the composition other than (A), (B), and (C) can be allowed.

### Example 3

The production of a specimen was performed under the same conditions as those in Specimen 1, other than the points that as the starting materials, (A): Cu of 20 parts by mass, (B): W of 79.5 parts by mass and Ni of 0.5 parts by mass, and (C): SrB₂O₄ of 0.5 external parts by mass was used, and the atmosphere of infiltration was changed from the H₂ atmosphere to the mixed atmosphere of H₂ and Ar. For this specimen, the same test and evaluation as those for Specimen 1 were performed. As a result, it was confirmed that the specimen could be suitably used as the electric-discharge machining electrode as shown below.

Machining speed of 90.0 mm/sec, Wear ratio of 8.9%, and the surface roughness of 15.0 Ry(μm).

The specimen is referred to as Specimen 200. When Specimen 200 was observed by EPMA mapping and X-ray diffraction, there was a portion in which Sr, Ni, W, and O were observed in the same portion together with Cu, W, W-—i alloy, and Sr₂B₂O₅. Thus, the investigation was performed by X-ray diffraction, it was confirmed that they were Sr(Ni. W)_{0.5}O₃ and B₂O. By the X-ray diffraction, the peak ratio was obtained, and converted into the mass ratio, and then converted by using the mass of (A) and (B) as 100 parts by mass, thereby obtaining the following components, respectively.

(A) Cu=20.0 parts by mass
(B) W=79.2 parts by mass, Ni=0 parts by mass, W—Ni alloy=0.8 parts by mass
(C) the sum of SrB₂O₄ and Sr₂B₂O₅=0.3 external parts by mass
(D) Sr(Ni. W)_{0.5}O₃=0.1 external parts by mass
(E) B₂O=0.1 external parts by mass

From these results, it was considered that Sr and parts of B and O which formed the borate compounds were decomposed in the sintering of the skeleton, the parts formed a complex oxide of Sr, Ni and W, and the remaining B and O form B₂O. The (D):Sr(Ni.W)_{0.5}O₃ is produced because the borate compounds (C): (SrB₂O₅) of alkaline metal has a relatively low melting point such as 1000 to 1300° C. Accordingly, it is considered that, in the mixed atmosphere, as the sintering temperature increases, the generation of (D) and B₂O as (E) also increases.

For this reason, an experiment was performed by varying only the sintering temperature in the range of 1050 to 1200° C., by using the same starting materials and by the same producing method. With respect to 100 parts by mass of the total mass of (A) and (B), Sr (Ni. W)_{0.5}O₃ of 0.1 external parts by mass at the minimum and 5 external parts by mass at the maximum, and B₂O of 0.1 external parts by mass at the minimum and 3 external parts by mass at the maximum were measured.

The characteristics of the electro-discharge machining electrode containing (D):Sr(Ni. W)_{0.5}O₃ and (E):B₂O in the above-mentioned ranges were substantially the same as those of Specimen 1. As for the specimen in which (D) and (E) were less than 0.1 external parts by mass, the production and the observation were difficult, so that the existence of (D) and (E) was not confirmed in the specimen.

### Example 4

The starting materials which were the same as those of Specimen 105 in Example 2 were used, but the oxygen concentration of the sintering atmosphere and the sintering time in the production process of the borates of Sr were adjusted, thereby obtaining the borates of Sr of different form. The oxygen concentration and the sintering time in the sintering are shown in Table 10.

The thus-obtained Sr borates were used as the material, and the other process and evaluation were the same as those of Specimen 105 in Embodiment 2. The evaluation results at this time and the forms of the Sr borates as the material of the electro-discharge machining electrode are shown in Table 11. The forms of the Sr borates are investigated by X-ray diffraction.

TABLE 10

| | Oxygen | Sintering |
|---|---|---|
| Specimen | concentration | time |
| No. | (atm) | (min) |
| 105 | 0.20 | 30 |
| 151 | 0.20 | 60 |
| 152 | 0.20 | 180 |
| 153 | 0.25 | 30 |
| 154 | 0.30 | 30 |
| 155 | 0.50 | 30 |

TABLE 11

| | Form of borate compounds | | | |
|---|---|---|---|---|
| | (parts by volume with | Machining | Wear | Surface |
| Specimen | respect to the whole | speed | ratio | roughness |
| No. | of borate compounds) | (mg/sec) | (%) | Ry(μm) |
| 105 | 1.0SrB₂O₄ | 85.0 | 11.2 | 15.8 |
| 151 | 0.5SrB₂O₄ + 0.5Sr₂B₂O₅ | 88.7 | 8.4 | 16.3 |
| 152 | 0.2SrB₂O₄ + 0.8Sr₂B₂O₅ | 89.0 | 8.3 | 16.3 |
| 153 | 0.01SrB₂O₄ + 0.99Sr₂B₂O₅ | 90.1 | 8.0 | 16.0 |
| 154 | 0.8Sr₂B₂O₅ + 0.1SrB₂O₄ + | 89.8 | 8.3 | 15.9 |
| | 0.1*A | | | |
| 155 | 0.4Sr₂B₂O₅ + 0.6*A | 83.5 | 11.9 | 15.9 |

In the table, the symbol *A indicates the mixture of a = 1, b = 1, c = 3; a = 1, b = 4, c = 7; and a = 2, b = 3, c = 11, when the strontium borates is expressed by SrₐB_{b}O_{c}.

From the results shown in Table 11, it was found that as the oxygen concentration in the production process of the borates of Sr increased, and as the sintering time increased, the degree of oxidization was advanced, and the ratio occupied by the oxygen in the borate compounds was increased. In the borate compounds, the first one which is particularly easily produced and excellent in electric discharge characteristics is Sr₂B₂O₅, and the second one is SrB₂O₄. The specimen containing Sr₂B₂O₅ of 0.5 parts by volume or more with respect to the volume of 1 of the borate compounds was especially suitable. It is suitable that Sr₂B₂O₅ is 0.1 parts by volume or more. The upper limit of the parts by volume of Sr₂B₂O₅ is 0.99 parts by volume. This is because it is difficult to obtain Sr₂B₂O₅ which is pure more than this.

If it is assumed that Sr₂B₂O₅ of x parts by volume, SrB₂O₄ of y parts by volume, and borate compounds which are different from both of them of z parts by volume are contained, Specimens 151 to 154 satisfy all of the relationships of (1) x≧0.1, y≧0.1, (2) x+y≧0.5, and (3) x+y+z=1. The characteristics of these specimens are excellent in the machining speed and the wear ratio, and the characteristics are superior to Specimen 105.

The borate compounds other than Sr₂B₂O₅ and SrB₂O₄ are difficult to be stably obtained, and have inferior electric discharge characteristics as compared with the two, so that such borate compounds are preferably set to be less than 0.5 parts by mass. Specimen 155 contains Sr₂B₂O₅ of 0.4 parts by volume which is a low ratio, and contains the other borate compounds at high ratios. In this case, the characteristics are substantially the same as those of Specimen 5, and are inferior to those of Specimens 151 to 154.

### Example 5

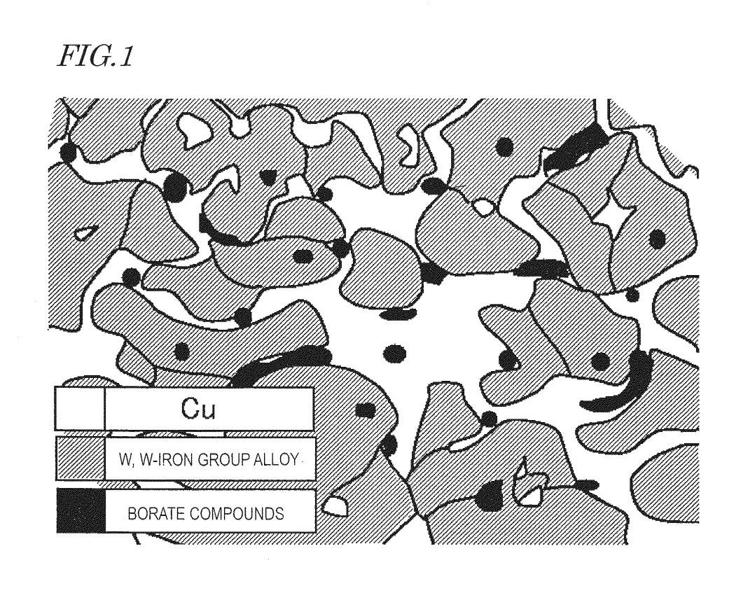

As shown in Table 12, the mixing time by Henschel mixer was varied for mixing the M2 powder, the iron group metal powder, and the borates powder, thereby producing a plurality of specimens similar to Specimen 104. As a result, five kinds of Specimens No. 301 to No. 305 having mutually different ratios of borate compounds existing in the grain boundary between M1 (Cu) and M2 (W) were obtained. The schematic diagram of the thus-obtained specimen is shown in FIG. 1. As is seen from FIG. 1, these specimens have a fundamental organization in which tungsten elements (and the alloys of tungsten and iron group metal) are necking, and the space between the particles is filled with Cu. In addition, a large amount of borate compounds existed in these grain boundaries in the form of particles, but part of them also existed in the particles of W and Cu. The ratio at which the borate compounds existed was obtained by observing these specimens by SEM (Scanning Electron Microscope) and calculating the ratio of areas between the borate compounds existing in the grain boundary and the borate compounds existing in the particles (crystals). The electric discharge characteristics of these specimens were more advantageous as the ratio of borate compounds existing in the grain boundary was 0.5 parts by volume or more. As compared with the comparative examples, the machining speed and the wear ratio of Specimen 305 were both superior, but inferior to those of Specimens 301 to 304.

TABLE 12

| | Powder mixing time of | Ratio at which borate | | | |
|---|---|---|---|---|---|
| | M2, iron group metal, | compounds exist in | Machining | Wear | Surface |
| Specimen | and borate compounds | the grain boundary | speed | ratio | roughness |
| No. | (mim) | (parts by volume) | (mg/sec) | (%) | Ry(μm) |
| 301 | 600 | 0.84 | 89.0 | 7.5 | 16.5 |
| 302 | 240 | 0.70 | 88.2 | 7.5 | 16.6 |
| 303 | 30 | 0.66 | 88.5 | 7.7 | 16.4 |
| 304 | 10 | 0.50 | 84.2 | 8.8 | 17.2 |
| 305 | 5 | 0.35 | 75.2 | 12.6 | 19.8 |

### Example 6

Particles of borate compounds as the material for skeleton were pulverized by an attritor before mixing. By varying the pulverizing time, fixe kinds of particle diameters were obtained. The respective particle diameters are shown in Table 13.

By using the thus-obtained five kinds of borate compounds powder having different particle diameters, Specimens 401 to 405 were produced. Each of the specimens is constituted by Cu of 20 parts by mass, W of 79 parts by mass, Ni of 1 parts by mass, and SrB₂O₄ of 1.4 external parts by mass. Only the particle diameters of the borate compounds are different. The tests and the evaluations were performed in the same way as in Example 2, and the results shown in Table 14 were obtained.

As the particle diameter of powder of borate compounds as the material increases, the surface roughness is increased, thereby degrading the electric discharge characteristics. The desired ranges are, as is seen in the borate compounds of Specimens 401 to 404, 20 μm or less of the average particle diameter, and 150 μm or less of the maximum particle diameter. Specimen 405 was apparently superior in the machining speed and the wear ratio as compared with the comparative examples, but was inferior to those of Specimens 401 to 402.

TABLE 13

| | Average particle | Maximum particle |
|---|---|---|
| Specimen | diameter of borate | diameter of borate |
| No. | compounds(μm) | compounds(μm) |
| 401 | 0.1 | 3 |
| 402 | 1 | 10 |
| 403 | 10 | 100 |
| 404 | 20 | 150 |
| 405 | 50 | 300 |

TABLE 14

| | Machining | Wear | Surface |
|---|---|---|---|
| Specimen | speed | ratio | roughness |
| No. | (mg/sec) | (%) | Ry(μm) |
| 401 | 89.0 | 7.5 | 14.5 |
| 402 | 86.2 | 8.3 | 15.1 |
| 403 | 82.1 | 9.2 | 16.4 |
| 404 | 80.9 | 11.3 | 17.7 |
| 405 | 75.2 | 14.2 | 20.0 |

As described above, according to the embodiments of the present invention, the electro-discharge machining electrode is produced by adding borates of Mg, Ca, Sr, Ba, Sc, Y, and lanthanide and the iron group metal by appropriate amounts to the Cu(Ag)—W(Mo) material. When the thus-produced electro-discharge machining electrode is used, the machining speed and the electrode wear ratio can be improved, as compared with the case where an electro-discharge machining electrode to which oxides or borides are added. In addition, in the preferred embodiments, by mainly using borate compounds expressed by “M3₂B₂O₅” and “M3B₂O₄” as the borate compounds, the electric discharge characteristics can be particularly improved.

### INDUSTRIAL APPLICABILITY

The electro-discharge machining electrode of the present invention is suitably used as an electrode for die-sinking electro-discharge machining.

1. An electro-discharge machining electrode used for electro-discharge machining, formed of a material containing the following (A), (B), and (C), in which the sum of the masses of the (A), (B), and (C) accounts for 95% by mass or more and 100% by mass or less of the total mass:
(A): M1 of 5 to 40 parts by mass;
(B): M2 metal of 100 parts by mass in total together with the (A), always containing M2, and containing an alloy of M2 and iron group metal or a simple substance of iron group metal; and
(C): M3 borates of 0.05 to 8 external parts by mass per 100 parts by mass of the total mass of the (A) and the (B), wherein
M1 is at least one of Cu or Ag, or an alloy thereof,
M2 is at least one of W or Mo, or an alloy thereof, and
M3 is at least one selected from a group consisting of Mg, Ca, Sr, Ba, and rare earth metals.

2. The electro-discharge machining electrode of claim 1, wherein the sum of the mass of the simple substance of iron group metal and the mass of the alloy of M2 and iron group metal is 0.05% to 2.5% by mass per the sum of the mass of (A) and the mass of (B).

3. The electro-discharge machining electrode of claim 1, formed of the material further containing the following (D) and (E), wherein the sum of the mass of (A), (B), and (C) and the mass of (D) and (E) accounts for 95% by mass or more and 100% by mass or less of the total mass:
(D): a complex oxide of 0.1 to 5 external parts by mass per the sum of the mass of (A) and the mass of (B), when the sum of the mass of (A) and the mass of (B) is 100 parts by mass, the complex oxide containing the M2, the iron group metal, and at least one of Ca, Sr, Ba, and rare earth metals; and
(E): a boron oxide of 0.1 to 3 parts by mass per the sum of the mass of (A) and the mass of (B), when the sum of the mass of (A) and the mass of (B) is 100 parts by mass.

4. The electro-discharge machining electrode of claim 1, wherein the borates of (C) can be expressed by M3ₐB_{b}O_{c}, and
the ratio of the borates in which a=2, b=2, and c=5 is 0.5 parts by volume or more and 0.99 parts by volume or less when the total volume of the borates is 1.

5. The electro-discharge machining electrode of claim 1, wherein the borates of (C) can be expressed by M3ₐB_{b}O_{c}, the borates containing:
first borates expressed by a=2, b=2, and c=5, and accounting for x parts by volume;
second borates expressed by a=1, b=2, and c=4, and accounting for y parts by volume; and
third borates accounting for z parts by volume, the third borates being different from both of the first borates and the second borates, and
the aforementioned x, y, and z satisfy the following relationships (1), (2), and (3):
x≧0.1,y≧0.1 (1)
x+y≧0.5, and (2)
x+y+z=1. (3)

6. The electro-discharge machining electrode of claim 1, wherein when the total volume of the borates of (C) is 1 parts by volume, 0.5 parts by volume of the borates are dispersed in grain boundaries of M1, M2, a simple substance of the iron group metal, and the alloy of M2 and iron group metal.

7. The electro-discharge machining electrode of claim 1, wherein an average particle diameter of the borates of (C) is more than 0 μm and equal to or less than 20 μm, and the maximum particle diameter is more than 0 μm and equal to or less than 150 μm.
